(19) United States
(12) Patent Application Publication
(10) Pub. No.: US 2011/0239525 A1
(43) Pub. Date: Oct. 6, 2011

(54) MULTI-FUNCTIONAL AND COMPARTMENTALIZED STORAGE UNIT

(76) Inventor: ELEXIS MORALES, Tampa, FL (US)

(21) Appl. No.: 12/750,547

(22) Filed: Mar. 30, 2010

(51) Int. Cl. A01K 97/06; A01K 97/04; A01K 97/10

(52) U.S. Cl. 43/54.1

(57) ABSTRACT

A multi-compartmental storage unit for transporting and storing items comprising: a multi-compartment body, where said body includes multiple compartments for storage of items; a plurality of wheels for moving the body over terrain; at least one pull lever with a handle, where said at least one pull lever provides a means for pulling the body over terrain; and a plurality of support devices attached to the body, where said support devices provide a means to transport items with the body. The multiple compartments may include a cooler compartment, a supplies compartment and a bait compartment. The plurality of wheels may include a set of three wheels, where two wheels are aligned on an axle along one side of the body and a single wheel on the opposite side of the body.

### BACKGROUND OF THE INVENTION

1. Field of Invention

The present invention relates to a mobile and compartmentalized storage units to provide a means to transport fishing tackle, food and supplies to and from a fishing location.

2. Description of Related Art

Recreational fishing is a sport that is enjoyed by many individuals. Fishing involves the casting of a line and bait into a body of water to catch a fish on a hook that is usually at the end of the line which contains bait. A recreational fisherman usually needs to transport various items to and from their particular location of fishing in order to successfully accomplish their goals. A fisherman must utilize various equipment and tackle such as poles, bait, rods, reels, hooks, nets and other necessary equipment. In addition to the fishing equipment and tackle, the task of fishing usually involves long periods of waiting for a fish to bite on the bait. Many fishermen carry refreshments with them to their fishing spot. Further fishermen may also take additional equipment such as chairs or lounge chairs to recline in while fishing.

Prior art devices have been developed to assist fishermen in managing their equipment, bait and other accessories such as U.S. Pat. No. 5,305,544 which discloses a multi-compartment insulated chest for the fresh storage of bait and food. Such a device as the '544 patent is useful in providing an unitary storage unit for food items, bait and other supplies. Further development of such a multi-storage units may be advantageous to the fisherman. In particular it would be advantageous to have a device that includes mobility and sufficient storage compartments to provide a durable storage means.

### SUMMARY OF THE INVENTION

The present invention relates to a multi-compartmental storage unit for transporting and storing items comprising: a multi-compartment body, where said body includes multiple compartments for storage of items; a plurality of wheels for moving the body over terrain; at least one pull lever with a handle, where said at least one pull lever provides a means for pulling the body over terrain; and a plurality of support devices attached to the body, where said support devices provide a means to transport items with the body. The multiple compartments may include a cooler compartment, a supplies compartment and a bait compartment. The plurality of wheels may include a set of three wheels, where two wheels are aligned on a axle along one side of the body and a single wheel on the opposite side of the body. The at least one pull lever may extend from the single wheel. The support devices may include a plurality of rod holders and a brace for support of at least one folding chair.

### BRIEF DESCRIPTION OF DRAWINGS

FIG. 1 depicts storage with a multi-compartmental storage unit according to the present invention.

### DETAILED DESCRIPTION

The present invention relates to a multi-functional compartmentalized storage unit that provide a means for storage and transportation of items that may be needed or associated with a fishing trip. The multi-compartmental unit has insulated compartments for the storage of beverages, food, and bait. In addition to multiple insulated compartments, the storage unit according to the present invention includes a means for the storage of fishing poles or rods, chairs and an umbrella. The storage unit according to the present invention is portable and is transported on a set of wheels provided with a pole-like pull handle. The storage unit according to the present intervention allows a fisherman to manage and transport fishing equipment and accessories as may be needed during a fishing excursion.

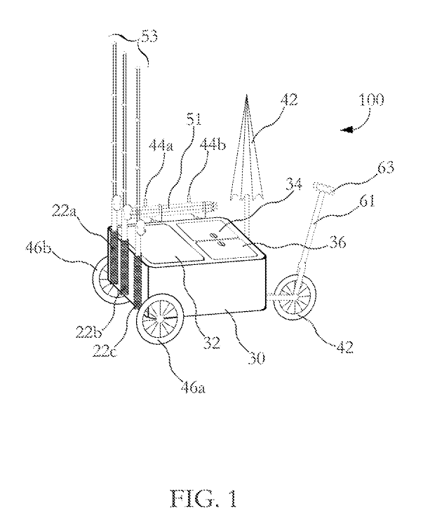

FIG. 1 depicts a Storage Unit 100 according to the present invention. The Storage Unit 100 includes a Multi-Compartment Body 30 that includes multiple compartments for the storage of various items. In one exemplary embodiment of the present invention, a Cooler Compartment 32 is provided along with a Supplies Compartment 34 and a Bait Compartment 36. The Supplies Compartment 34 is positioned adjacent to the Bait Compartment 36. In this particular embodiment, the Cooler Compartment 32 comprises the substantial majority of the Multi-Compartment Body 30. The Multi-Compartment Body 30 has a cuboidal shape that is positioned on wheels. Three wheels are provided for the movement of the Storage Unit 100, Wheels 46a, 46b are positioned at one end of the Multi-Compartment Body 30, at the opposite end a Single Wheel 42 is provided. The Wheels 46a, 46b are placed on a single axle. A Pole Lever 61 extends from the Single Wheel 42 and includes a Handle 63 provided at the top of the Pole Lever 61. The Single Wheel 42 is capable swiveling in order to provide steering capability.

The Storage Unit 100 therefore provides a mobile and multi-compartmental storage unit that assists a fisherman in managing food, equipment, and bait that may be needed while fishing. The Storage Unit 100 further includes a means for the storage of rods or reels that the fisherman may use while fishing. Along one side of the Multi-Compartment Body 30 a plurality of Rod Holders 22a, 22b, 22c are provided. Fishing Poles 53 are inserted into the holders and therefore may be secured while moving the Storage Unit 100. In addition to providing holders for the fishing poles, the Storage Unit 100 includes a Chair Holding Brace 44a, 44b which may be used to support a Folding Chair 51. An Umbrella 42 is also placed within a holder, not shown, on the opposite side of the Pole Holders 22a, 22b, 22c.

The Storage Unit 100 is a transportable unit that provides storage means for certain utensils, food, beverages, supplies and bait. The Front Wheel 42 includes the pole lever and may be used to steer and maneuver the unit over the surface area terrain. A fisherman may use the storage unit to manage the various equipment and tools that are needed for fishing. The instant invention has been shown and described in what it considers to be the most practical and preferred embodiments. It is recognized, however, that departures may be made there from within the scope of the invention and that obvious modifications will occur to a person skilled in the art.

What is claimed is:

1. A multi-compartmental storage unit for transporting and storing items comprising:
a. a multi-compartment body, where said body includes multiple compartments for storage of items;
b. a plurality of wheels for moving the body over terrain;
c. at least one pull lever with a handle, where said at least one pull lever provides a means for pulling the body over terrain; and
d. a plurality of support devices attached to the body, where said support devices provide a means to transport items with the body.

2. The multi-compartmental unit according to claim 1, where said multiple compartments include a cooler compartment, a supplies compartment and a bait compartment.

3. The multi-compartmental unit according to claim 1, where said plurality of wheels include a set of three wheels, where two wheels are aligned on a axle along one side of the body and a single wheel on the opposite side of the body.

4. The multi-compartmental unit according to claim 3, where the at least one pull lever extends from the single wheel.

5. The multi-compartmental unit according to claim 1, where said support devices include a plurality of rod holders and a brace for support of at least one folding chair.
